(19) United States
(12) Patent Application Publication
(10) Pub. No.: US 2026/0066671 A1
(43) Pub. Date: Mar. 5, 2026

(54) CAPACITIVE POWER SUPPLY ENHANCEMENT

(71) Applicant: George Ho Kwong, Huntington Beach, CA (US)

(72) Inventor: George Ho Kwong, Huntington Beach, CA (US)

(21) Appl. No.: 18/820,123

(22) Filed: Aug. 29, 2024

(51) Int. Cl. H02J 7/34; H02J 7/00

(52) U.S. Cl. CPC H02J 7/345; H02J 7/62; H02J 2105/46; H02J 2207/50

(57) ABSTRACT

The present invention concerns a power supply arrangement for a portable electronic device. The inventive arrangement uses a large value capacitor in the power supply circuitry to extend the operational life of the battery. The large capacitor builds up the power reserve thereby increasing current output. Because of the small footprint of the device, multiple smaller capacitors are connected in series to build up the large capacitor value. The arrangement preserves battery power by reducing the leakage typically present when using a single large capacitor. The arrangement also effectively reduces the battery's internal resistance.

### BACKGROUND OF THE INVENTION

The present invention relates to electronic circuits. More particularly, it is directed to an improved power supply for wearable electronic devices.

NFC, which is short for near-field communication, is a technology that allows devices like phones and smartwatches to exchange small bits of data with other devices and read NFC-equipped cards over relatively short distances. The technology behind NFC is very similar to radio-frequency identification (RFID) commonly used in the security cards and keychain fobs that you likely already use to get into your office or gym.

Wearable and portable devices such as smartphones, watches, and various wearable medical devices typically use NFC technology. A problem with wearable medical devices using NFC technology is battery life. Because the devices are generally small, with some about only an inch square with a thickness of less than an inch, small batteries such as button batteries are required. These batteries are fine for short term use but cannot be relied upon for long periods without charging or replacement.

Since the NFC reading and writing operation requires high power consumption, a typical button battery dies in short period of time. The button battery by nature has limited electrical current, but the NFC operation requires high current to maintain normal operation. The battery can be drained or damaged quickly due to the sudden high current demands by the NFC operation. The battery will stop working altogether when the power capacity depleted below 60% of the battery capacity.

Accordingly, there is a need to provide a power supply for an NFC device that is relatively small, and can maintain operational power over at least several months.

### BRIEF SUMMARY OF THE INVENTION

The present invention concerns a power supply arrangement for a portable electronic device. The inventive arrangement uses a large value capacitor in the power supply circuitry to extend the operational life of the battery. The large capacitor builds up the power reserve thereby increasing current output. Because of the small footprint of the device, multiple smaller capacitors are connected in series to build up the large capacitor value. The arrangement preserves battery power by reducing the leakage typically present when using a single large capacitor. The arrangement also effectively reduces the battery's internal resistance.

It is an object of the invention to provide an power supply for electronic devices.

It is another object of the invention to provide a long lasting power supply for NFC enabled devices.

It is another object of the invention to provide a power supply for NFC enabled devices that reduces battery internal resistance.

It is another object of the invention to provide a power supply for NFC enabled devices that stabilizes working current.

It is another object of the invention to provide a power supply for NFC enabled devices that prevents spike currents and reduces high current damage.

### BRIEF DESCRIPTION OF THE DRAWINGS

FIG. 1 shows a plan view of the circuit layout of the invention.

FIG. 2 shows a plan view of the circuit topography of the invention.

### DETAILED DESCRIPTION OF THE PREFERRED EMBODIMENTS

Some embodiments of the present invention will now be described more fully hereinafter with reference to the accompanying drawings, in which some, but not all, embodiments of the invention are shown. Indeed, various embodiments of the invention may be embodied in many different forms and should not be construed as limited to the embodiments set forth herein; rather, these embodiments are provided so that this disclosure will satisfy applicable legal requirements. Like reference numerals refer to like elements throughout. As used herein, the terms “data,” “content,” “information,” and similar terms may be used interchangeably to refer to data capable of being transmitted, received and/or stored in accordance with embodiments of the present invention. Thus, use of any such terms should not be taken to limit the spirit and scope of embodiments of the present invention.

Additionally, as used herein, the term ‘circuitry’ refers to (a) hardware-only circuit implementations (e.g., implementations in analog circuitry and/or digital circuitry); (b) combinations of circuits and computer program product(s) comprising software and/or firmware instructions stored on one or more computer readable memories that work together to cause an apparatus to perform one or more functions described herein; and (c) circuits, such as, for example, a microprocessor(s) or a portion of a microprocessor(s), that require software or firmware for operation even if the software or firmware is not physically present. This definition of ‘circuitry’ applies to all uses of this term herein, including in any claims. As a further example, as used herein, the term ‘circuitry’ also includes an implementation comprising one or more processors and/or portion(s) thereof and accompanying software and/or firmware. As another example, the term ‘circuitry’ as used herein also includes, for example, a baseband integrated circuit or applications processor integrated circuit for a mobile phone or a similar integrated circuit in a server, a cellular network device, other network device, and/or other computing device.

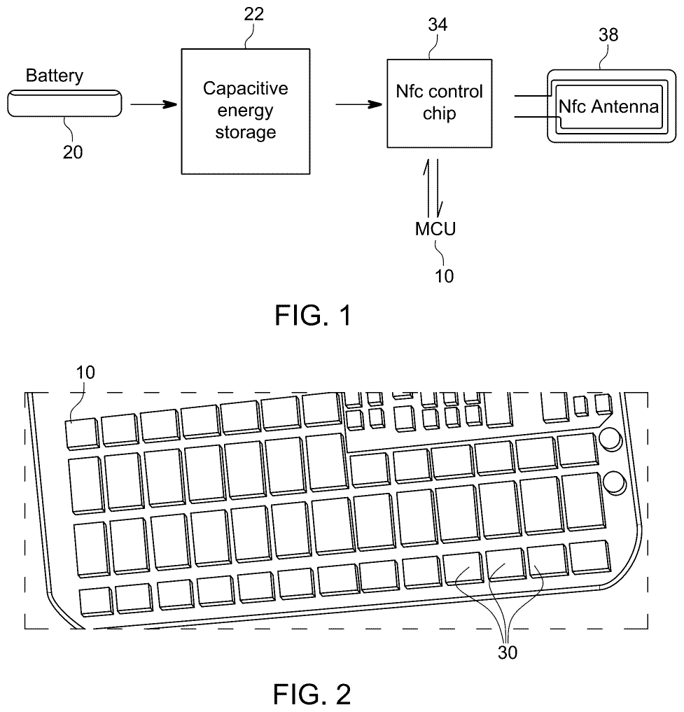

Referring now to FIGS. 1 and 2, the invention is shown. The invention is designed to be implemented on a standard PC board 10, which may be operatively connected to one or more other PC boards as would be apparent to one of skill in the art. The board 10 may be disposed inside of the housing (not shown) of e.g., a medical monitor such as a heart rate monitor, which requires a stable and long term power source. As can be seen in the simplified block diagram of FIG. 1, the primary power source is a battery 20. The battery 20 has to be of a small size to physically fit inside of the small housing of a typical NFC medical monitoring device, so a button type battery is used. A capacitance 22 is positioned in series with the battery 20 to deliver power to the NFC microcontroller, the battery and capacitance forming the power supply for the monitoring device. While the small generally disc shaped button battery provides sufficient power to operate the circuitry, long term operation without charging or battery placement is not possible. Accordingly, the present invention solves the problem by providing a large, energy storing capacitance 22.

A key aspect of the invention is that a single “large” capacitor cannot be used as the capacitance because of power leakage. A large capacitance can be defined as around 500 μF (microfarads). Therefore, an arrangement is required to supply the needed capacitance or energy storage capacity without using a large capacitor. The present invention solves the problem by providing a large capacitance using a series of smaller capacitors connected in series or daisy chained. As can be seen most clearly in FIG. 2, the individual small capacitors 30 can be connected to the board 10 in spaced relation until a desired large capacitance is obtained.

The capacitance 22 is electrically connected to a micro-controller unit 34 which controls transmission and reception of data to and from the monitoring device. An antenna 38 is connected to the micro-controller 34 for receiving and transmitting digital data and control signals.

The above description and drawings are only to be considered illustrative of exemplary embodiments, which achieve the features and advantages of the present invention. Modification and substitutions to specific process steps, system, and setup can be made without departing from the spirit and scope of the present invention. Accordingly, the invention is not to be considered as being limited by the foregoing description and drawings, but is only limited by the scope of the appended claims.

1. A power supply for an electronic circuit having a micro-controller unit comprising;
a battery;
a plurality of capacitors serially connected between said battery and said micro-controller to produce a large capacitance;
wherein said large capacitance extends battery life and protects against current surges.

2. The power supply of claim 1 wherein said electronic circuit is an NFC beacon.

3. The power supply of claim 1 wherein said circuit is for a portable device.

4. The power supply of claim 3 wherein said portable device is a wearable medical device.

5. The power supply of claim 1 wherein said battery life is extended to at least one year.
